(19) United States
(12) Patent Application Publication
(10) Pub. No.: US 2014/0037789 A1
(43) Pub. Date: Feb. 6, 2014

(54) Continuous Process and Apparatus for Making a Pita Chip

(71) Applicants: Donald Casimir BERNARD, Frisco, TX (US); Donna Jan DIERMEIER, Highland Village, TX (US); Tamer Morad ELSAWY, Frisco, TX (US); Ponnattu Kurian JOSEPH, Irving, TX (US); Renu MATHEW, Plano, TX (US); Sid SAMBASHIVAN, Plano, TX (US); Rogers WILLIAMS, McKinney, TX (US)

(72) Inventors: Donald Casimir BERNARD, Frisco, TX (US); Donna Jan DIERMEIER, Highland Village, TX (US); Tamer Morad ELSAWY, Frisco, TX (US); Ponnattu Kurian JOSEPH, Irving, TX (US); Renu MATHEW, Plano, TX (US); Sid SAMBASHIVAN, Plano, TX (US); Rogers WILLIAMS, McKinney, TX (US)

(73) Assignee: FRITO-LAY NORTH AMERICA, INC., Plano, TX (US)

(21) Appl. No.: 13/564,142

(22) Filed: Aug. 1, 2012

(51) Int. Cl. A21B 2/00; F26B 3/34; A21D 13/00; A21D 8/06; A21D 8/02

(52) U.S. Cl. 426/19; 426/502; 426/243; 426/302; 426/560; 34/256

(57) ABSTRACT

A continuous process and the accompanying equipment for making a chip product, such as pita chips. The process involves cutting sheeted dough into continuous longitudinal strips, and cooking them to form hollow tubes. In some embodiments, these tubes are split longitudinally. Also disclosed is a vacuum-assisted splitter. These bread tubes or strips are cured in an accelerated process. The bread tube is trimmed into chip-sized pieces. In one embodiment, the pita bread strips are cut into chip-sized pieces using a continuous, low-pressure water jet cutting system. The resulting chip-sized pieces are nearly uniform in size, shape, and texture.

### TECHNICAL FIELD

The present invention relates to a method for making pita bread and chips and other such products in a continuous operation.

### BACKGROUND

Pita bread is a type of flatbread—typically a round pocket bread—believed to have originated in the Middle East. The baking process typically involves forming, by rolling, a flat dough disk that is baked in a hot oven, usually in excess of 260° C., on a flat support surface. The pocket inside the finished loaf is created during cooking when the outside layers of the bread are seared, thus forming a cap that impedes the release of steam from the interior of the bread. This trapped steam puffs up the dough in the middle of the bread thus forming a pocket. As the bread cools and flattens, a pocket is left in the middle that can be later stuffed for making sandwiches and the like.

Pita chips are generally made by splitting and cutting or chopping pita bread loaves into chip-sized pieces. Making individual round pita bread loaves and cutting each loaf into chip-sized pieces is time consuming and is not conducive to an efficient, continuous operation. One prior art approach to this issue involves pressing a dough ball between two hot plates to form the pita loaf, and then cutting the loaf into smaller chip sizes. This approach is referred to as a dough ball press method followed by splitting and chopping of the bread loaves. The dough ball press method is not particularly efficient and has not demonstrated desirable throughput rates on continuous or semi-continuous product lines.

FIG. 1A depicts a cross-section of a pita bread loaf 100 made with a dough ball press method. Traditionally, the pita bread 100 is split manually by pulling apart the top half 102 from the bottom half 104. The pita bread generally 100 breaks apart at its natural splitting point 106. While this manual process gives the pita bread 100 a natural, artisan bread look, this is an inefficient and time-consuming process.

One attempt at improving upon the dough ball press method is found in U.S. Pat. No. 6,291,002 entitled “Method for Preparing Elongated Pita Bread” issued on Sep. 18, 2001, to inventor George Goglanian (the “Goglanian Patent”). The Goglanian Patent describes a process whereby a sheet of dough is cut longitudinally into long strips. These strips are run through an oven, thereby producing a tube-shaped bread product. Because a tube shape is not conducive to making into a flat chip, the Goglanian Patent teaches cutting this tube along its longitudinal edges into a top half and a bottom half of the pita bread tubes. These sections are cut into chip shapes, thus making chips of both the top and the bottom of the tube.

Goglanian Patent still has several inefficiencies. First, Goglanian routes bread after it departs a bread oven to a spiral cooler. This means that the bread strips must be cut at a certain length and transported away from a continuous operation. This cooling process is inefficient because it requires manual handling of the intermediate bread product.

Second, Goglanian's process requires a lengthy curing process for the partially cooked tubes prior to being longitudinally split. The moisture level inside the bread is about 42%, while the moisture level at the surface of the bread is about 28% prior to curing. This ambient curing step must take place before the bread is either split or cut in the prior art. The curing allows for an equal distribution of moisture throughout the bread to about 32% moisture by weight. The ambient curing step typically takes between 8 and 24 hours. In order to accommodate such a long dwell time, the bread is physically removed from the processing line and manually placed in plastic bags during the ambient curing step. This ambient curing step is not conducive to an efficient continuous process.

Third, the tubes need to be cut along its cross-sectional center for optimal efficiency. If the tubes are cut off-centered, which normally occurs in practice, it results in significant product loss or wastage. The traditional mechanical splitting method results in significant product wastage. As shown in FIG. 1B, when the loaf 108 expands in the pita oven, variations exist in the thickness of the loaf sides 102, 104, making the natural splitting point 106 of the loaf difficult to identify. Ideally, a split between the upper half 102 and the lower half 104 should occur at the natural splitting point 106. When split mechanically, a pita loaf 108 is fed through a set of rollers and split at its mechanical center reflected by the location of the cutting devices rather than at the natural splitting point 106. As a consequence, the cutting device splits the upper half 102 from the lower half 104 at some point above or below the naturally formed intersection 106. For example, as shown in FIG. 1B, the bottom half 104 is much thicker than the top half 102. If the cutting device splits the loaf 108 at the midpoint of its height, the top half 102 will have two layers. Later during the processing, the top half 102 further split into two pieces or the thinner layer crumbles. This is part of the reason why an inefficient separation and wastage due to product breakage results.

Consequently, a need exists for a process that produces pita chips more efficiently. Such process should be capable of throughput rates typical of sheeter lines and minimize plant footprint used by the equipment.

### SUMMARY OF THE INVENTION

In accordance with one aspect of the present invention, an improved continuous process and apparatus for making a pita chip is provided which substantially eliminates or reduces disadvantages associated with previous systems and methods.

One embodiment of the process disclosed herein involves sheeting bread dough into a continuous dough sheet; cutting the continuous dough sheet longitudinally into continuous dough strips; cooking a continuous dough strip in a continuous oven, thereby producing a continuous bread tube, wherein the continuous bread tube comprises a cavity, a top surface, and a bottom surface; curing the continuous bread tubes in less than about 60 seconds; and trimming the continuous bread tubes into chip-sized pieces using a trimmer.

In some embodiments, the continuous, accelerated curing step occurs in a radio frequency oven. In most embodiments, the curing step is complete in less than about 60 seconds. In embodiments where the continuous bread tubes are split longitudinally, a convection oven is optionally used.

In some embodiments, the dough sheets undergo a proofing before cooking In some embodiments, the continuous bread tube is sprayed with anti-adhesive liquid to remove tackiness its surfaces. In one embodiment, trimming exposes the inner cavity (or the crumb side) of the continuous bread tubes. In other embodiments, the inner cavity is exposed by splitting the continuous bread tubes longitudinally.

Another embodiment of the process disclosed herein involves sheeting bread dough into a continuous dough sheet; cutting the continuous dough sheet longitudinally into continuous dough strips; cooking a continuous dough strip in a continuous oven, thereby producing a continuous bread tube, wherein the continuous bread tube comprises a cavity, a top surface, and a bottom surface; splitting the continuous bread tube longitudinally into a top half and a bottom half using a splitting mechanism assisted by vacuum technology; curing the continuous bread tube in less than about 60 seconds; and trimming the continuous bread tubes into chip-sized pieces using a trimmer.

In some embodiments, transporting the continuous bread tubes is accomplished using a top vacuum conveyor, wherein the top vacuum conveyor is coupled to the top surface of the continuous bread tube. In another embodiment, the continuous bread tube is transported using a bottom vacuum conveyor registered with the top vacuum conveyor, wherein the bottom vacuum conveyor is coupled to the bottom surface of the continuous bread tube. In an alternative embodiment, the splitting mechanism is coupled to vacuum rollers.

In some embodiments, a filling is applied between the top half and the bottom half of the bread tube. In one embodiment, the top and the bottom halves of the continuous bread tube are transported together using a single-tier takeaway conveyor. Alternatively, the top and bottom halves of the continuous bread tube are transported separately using a top takeaway conveyor and a bottom takeaway conveyor, respectively.

Certain embodiments of the present invention may provide a number of technical advantages. For example, according to one embodiment, the pita chip production process is substantially continuous with minimal amount of manual handling and significantly shorter cooling or curing times. Another technical advantage in particular embodiments is uniform pita chip product with decreased product wastage. Also, some embodiments of the disclosed process produce continuous bread tubes with less wrinkled surface, which results in further reduction of product wastage during the optional splitting step. Furthermore, some embodiments produce split pita chips with crumb exposure while other embodiments produce two-layered pita chips. Yet another technical advantage associated with one embodiment of the present invention is its versatility. Several steps in the disclosed process may be interchanged in the sequence. The disclosed process, along with the accompanying equipment, provides for a continuous process that produces pita chips that eliminates lengthy curing and cooling times and minimizes wastage. Such process provides for substantially increased throughput and minimal plant footprint.

### BRIEF DESCRIPTION OF THE DRAWINGS

For a more complete understanding of the present invention and its advantages, reference is made to the following description, and the accompanying drawings, in which:

FIG. 1A is a cross-sectional view of the prior art manual splitting of a pita loaf;

FIG. 1B is a cross-sectional view of the prior art mechanical splitting of a pita loaf;

FIG. 2 is a flow chart showing the steps of one embodiment of Applicants' method;

FIG. 3A is a cross-sectional view of the of one embodiment of Applicants' splitter;

FIG. 3B is a schematic view of the of one embodiment of Applicants' splitter;

FIG. 3C is a schematic view of the of one embodiment of Applicants' splitter;

FIGS. 4A and 4B are schematic views of two embodiments of the take away conveyors downstream of the splitting unit;

FIG. 5 is a schematic side cut away view of one embodiment of Applicant's water jet cutting unit; and

FIGS. 6A and 6B are cross-sectional views of one embodiment of Applicant's strip cutting unit.

FIG. 7 is a schematic view of the of one embodiment of Applicants' chip cutting unit

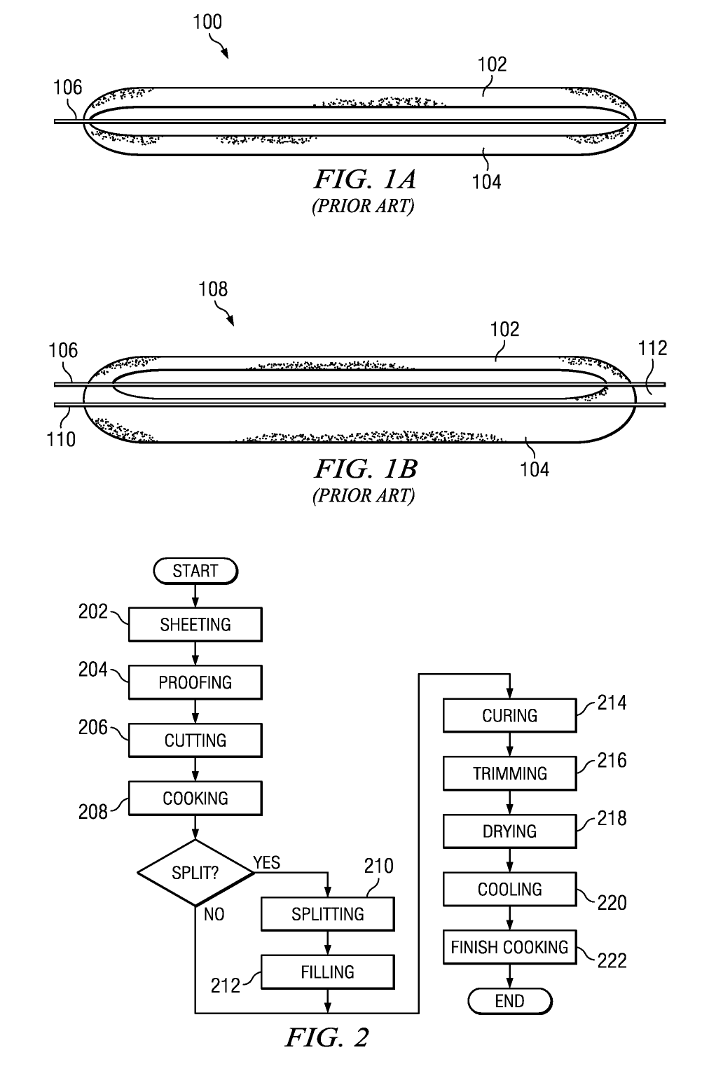

### DETAILED DESCRIPTION

It should be understood at the outset that although illustrative implementations of one or more embodiments are provided below, the disclosed systems and methods may be implemented using any number of techniques. The disclosure should not be limited to the illustrative implementations, drawings, and techniques illustrated below, but may be modified within the scope of the appended claims along with their full scope of equivalents. Unless otherwise noted, like elements will be identified by identical numbers throughout all figures.

FIG. 2 shows one embodiment of Applicants' process 200 illustrating various steps in the process 200 pursuant to embodiments of Applicants' invention. After mixing of a bread dough, the dough is sheeted 202 into a continuous sheet of dough. In one embodiment, the dough sheet is optionally proofed 204. The dough sheet is then cut 206 into two or more continuous dough strips. Depending on the embodiment practiced, the dough strips proceed directly from the sheeting step 202 to a cooking step 208, or emerge from the proofing step 204 to proceed to the cooking step 208 to form bread tubes. In some embodiments, the bread tubes are optionally split 210 longitudinally. In other embodiments, bread tubes proceed to subsequent steps as unsplit tubes to produce two-layered pita chips. Bread tubes are optionally filled 212 with fillings after the splitting step 210. The bread tubes are cured in an accelerated curing step 214. In one embodiment, a water jet trimmer is used at step 216 to cut the bread tubes into chip-sized pieces. The chip-sized pieces are optionally dried 218 and cooled 220 to remove excess moisture from the water-jet trimming step 216. The chip-sized pieces are then finish cooked 222 to produce a final product. In various embodiments, as further described below, Applicants' process 200 is capable of interchanging the sequence of some of these steps.

In various embodiments, Applicants' process 200 is carried out with a continuous system having a plurality of unit operation. As used herein, a unit operation means a component of the continuous system operable to carry out one or more steps of the process 200. For example, the cooking step 208 occurs in an appropriate unit operation, which, in one embodiment, would be a continuous cooking oven. Another example of unit operation is the water-jet trimmer used at the trimming step 216. Other unit operation will be described in further detail below.

### A. Sheeting, Proofing, and Cutting Steps

Table 1 below shows an example of the dough formula used to produce a pita chip in one embodiment.

TABLE 1

| Ingredient | Weight Percentage |
|---|---|
| Enriched Wheat Flour | 30-62% |
| Whole Wheat Flour | 0-31% |
| White Whole Wheat Flour | 1-5% |
| Sugar | 1-5% |
| Salt | 0-5% |
| Oat Fiber | 0-5% |
| Yeast | 1-5% |
| Actual water | 31-34% |

Ingredients, such as those listed in Table 1, are first mixed by methods known in the art to form sheetable dough prior to the sheeting step 202.

One embodiments of Applicants' process 200 begins with a sheeting step 202. As used herein, sheeting 202 means forming a continuous sheet of bread dough. In one embodiment, the sheeting step 202 is a low-stress sheeting operation. A sheeter means any mechanical means of forming a continuous sheet of dough. In one embodiment, the sheeter involves two or more sheeter roller pairs such that the thickness of the sheet is gradually reduced, thereby limiting the work imparted to the dough by the sheeters. In one embodiment, sheeter forms the dough sheet to a final thickness of about 0.2 to 0.5 centimeter (cm).

In one embodiment, a continuous conveyor system transports the continuous dough sheet to the proofing step 204. A proofer is food processing equipment that allows the dough to rise in a warm, humid environment for a period of time before further processing. A proofer box is a chamber that is humidity- and temperature-controlled, for example, at about 50% relative humidity and about 32° C. As used herein, proofing 204 means subjecting the continuous sheet of pita dough to proofer equipment or a proofer box as described. Proofing 204 relaxes the stress in the dough and allows the yeast to work. In one embodiment, the proofing time varies from zero to 20 minutes, depending upon the amount of flour in the dough, the amount of yeast in the dough, and the preferred texture of the end product. A softer textured product, for example, typically needs a longer proofing time than a harder textured product.

After the proofing step 204, a conveyor transports continuous dough sheets through a cutter to a cutting step 206. In an alternative embodiment, the cutting step 206 occurs prior to the proofing step 204. A continuous cutter cuts 206 the continuous dough sheet into longitudinal flat strips or, stated differently, two or more narrower continuous sheets. Some embodiments of the cutter also make shapes other than longitudinal flat strips, such as continuous longitudinal hexagonal shapes and longitudinal round shapes. In some embodiments, the longitudinal flat strips are slightly spread apart to prevent them from sticking to each other. In one embodiment, the dough strip width is from about 20 to from 26 cm. Relatively wider strips of dough are used to minimize breakage and loss in some embodiments because it is easier to split wider strips. Another advantage of using wider strips of dough is that they have a decreased tendency to stick to each other, which allows Applicants' process 200 to skip the option spreading step. Because there is no need to provide for gaps in such embodiments, the process 200 is capable of making the strips as wide as the conveyor width divided by the number of strips desired. In embodiments that have narrower strips (e.g., less than about 3 cm), the strips are optionally spread apart slightly to prevent re-adhesion.

### B. Cooking Step

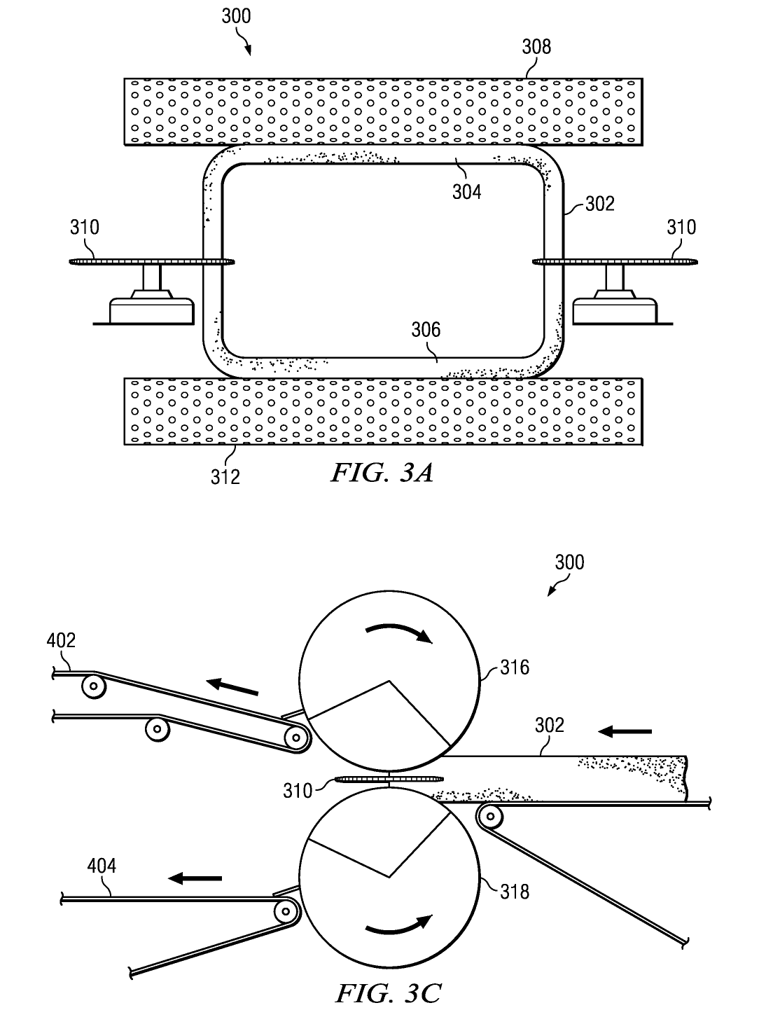

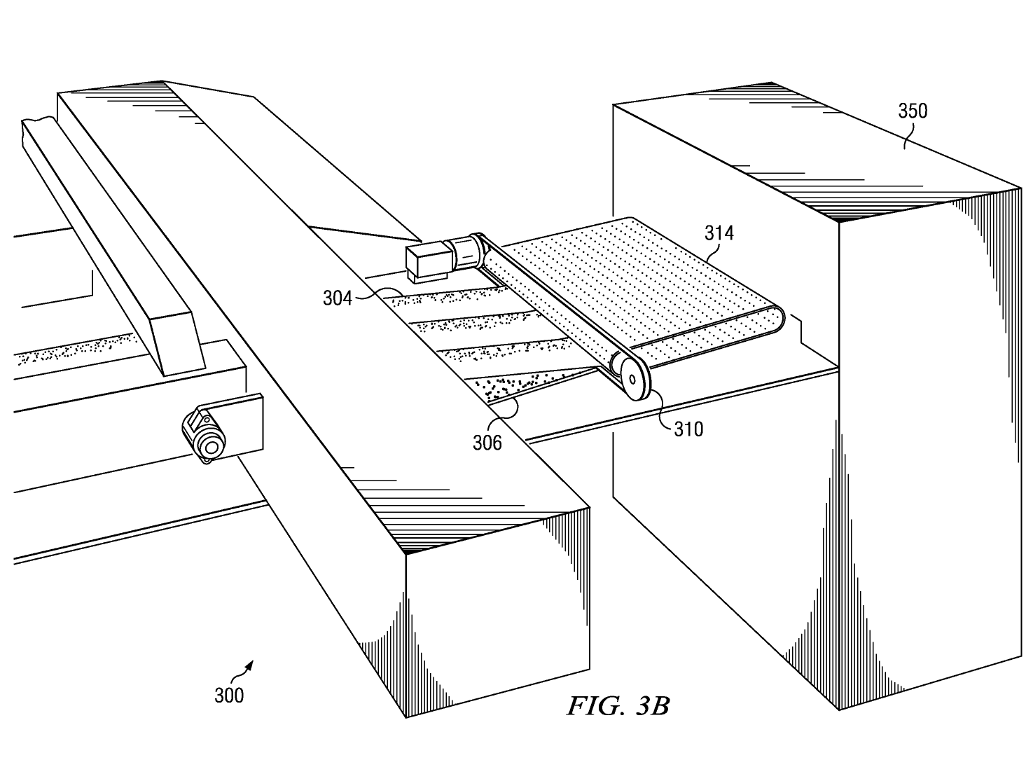

At the cooking step 208, the dough strips are formed into continuous bread loaves 302 (see FIG. 3A) in a cooking oven 350 (see FIG. 3B). The cooking oven 350 is any type of oven capable of baking dough products at sufficiently high temperatures. In one embodiment, the cooking oven 350 is a two-zoned oven set at temperatures in the range of about 300° C. and about 600° C. In one embodiment, the two zones are set at about 595° C. and 575° C. for zones 1 and 2, respectively. In some embodiments, the dwell time through the oven ranges between about 6 and 60 seconds, depending on product thickness and heat intensity.

During the cooking step 208, the dough strips puff up and form a cavity in the center of each strip (see FIG. 3A). This results in tubes of bread 302. “Pita bread tube,” “pita tube,” “bread tube,” “unsplit tube,” or any of their plural forms (collectively 302) are used interchangeably to refer to the partially cooked continuous bread product exiting the cooking step 208 that has a cavity in the center of the bread.

Upon exiting the cooking oven 350 after the cooking step 208, the bread tubes 302 are only partially cooked, and have about 32% water by weight in one embodiment. Further, the bread tubes 302 are still tacky in the middle and pliable, having a higher moisture level in the interior of each loaf as compared to the exterior of the loaf. In some embodiments, the bread tubes 302 maintain their tube-like structure and the top 304 and bottom 306 layers do not re-adhere together.

### C. Optional Splitting Step

1. Split-Tubes

The pita tubes 302 exiting the cooking oven 350 may be processed in various ways. In one embodiment, the splitting step 210 (FIG. 2) uses a splitter 300 (see FIGS. 3A, 3B, and 3C) to split the continuous bread tubes 302. As used herein, a splitter 300 means any cutting equipment operable to split the continuous bread tube 302 longitudinally. Longitudinally means along the length of the continuous bread tube 302. Alternatively, Applicants' process 200 bypasses the optional longitudinal splitting step 210, and the continuous, unsplit tubes 302 proceed directly to subsequent steps.

In some embodiments, the continuous pita tubes 302 are split 210 longitudinally with the aid of a vacuum apparatus. Such vacuum apparatus includes any vacuum equipment capable of transporting the continuous pita tubes 302 through the splitter 300 while maintaining (holding by way of the vacuum) the tubular structure. Some examples of suitable vacuum apparatus includes vacuum conveyor(s) 308, 312, 314 (see, e.g., FIGS. 3A and 3B) or vacuum rollers 316, 318 (see, e.g., FIG. 3C). The bread tube 302 is still pliable upon exiting the cooking oven 350. In some embodiments, the bread tube 302 are kept taut as the upper vacuum conveyor 308 pulls on the top side 304 and the lower vacuum conveyor 312 pulls on the bottom side 306. The bread tube 302, because it is pliable, becomes more uniformly shaped as it is being pulled evenly by the two vacuum conveyors 308, 312. In various embodiments, the vacuum conveyors are capable of being modified to accommodate any shape of pita bread, including round or hexagonal shapes.

In some embodiments, as seen in FIG. 3A, bread tubes 302 are held in place by a vacuum conveyor system comprising two vacuum conveyors 308, 312. The upper vacuum conveyor 308 is coupled to the top side 304 of the bread tube and the lower vacuum conveyor 312 is coupled to the bottom side 306 of the bread tubes 302. The upper vacuum conveyor 308 is registered with lower vacuum conveyor 312 to synchronize their movement to ensure that the bread tubes 302 are not subjected to any unwanted longitudinal shearing action. As used herein, registered means that two vacuum conveyors 308, 312 are moving at the substantially same velocity, in substantially the same direction, at substantially the same time. While FIG. 3B shows the vacuum conveyor 314 as ending shortly before the band saw 310, this is merely for illustrative purposes to show the bread tube 302 being split. In various embodiments, the vacuum conveyors 308, 312 are used any time beginning from the point where the bread tubes 302 are removed from the heat after cooking step 208 (FIG. 2) until the vacuum conveyors 308, 312 are no longer needed.

In an alternative embodiment, a single vacuum conveyor 314 maintains the walls of the tubes 302 taut by lifting the top section 304 with only the upper conveyor 314 (see FIG. 3B). In another embodiment, the bread tubes 302 maintain their hollow structures. In such embodiments, vacuum rollers 316, 318 are used to hold the bread tubes 302 just near the splitting mechanism 310 (see FIG. 3C) instead of full-length vacuum conveyors 308, 312. The upper vacuum roller 316 is registered with lower vacuum roller 318 in such embodiments.

One of the advantages of using a single vacuum conveyors 314, vacuum conveyors 308, 312, or vacuum rollers 316, 318—in addition to maintaining the tube structure—is that the tubes 302 capable of being uniformly cut and thus minimize product wastage.

In one embodiment, as illustrated in FIG. 3A, the two-layered vacuum conveyors 308, 312 are spaced to obtain a slightly flattened, substantially rectangular bread tube 302. The height of the space between the upper vacuum conveyor 308 and the lower vacuum conveyor 312 defines the height of the bread tube. Placing the splitting mechanism 310 midway between the vacuum conveyors 308, 312 will split the bread tube down its vertical center. This results in top half 304 and bottom half 306 being nearly identical in size and shape, which leads to uniform final chip products. In an alternative embodiment, FIG. 3B, the vacuum rollers 316, 318 are spaced so that the bread tube 302 is squeezed down to a substantially rectangular cross-sectional shape near the splitting mechanism 310. In another embodiment, the single vacuum conveyor 314 is placed and oriented so that the bread tubes 302 are flattened to a substantially rectangular cross-sectional shape near the splitting mechanism 310. Converging the vacuum conveyors 308, 312 or the vacuum rollers 316, 318 at the splitting mechanism 310 helps to further achieve a more uniform split product.

In one embodiment, as seen in FIG. 3A, the splitting mechanism 310 is horizontal rotary blades. The horizontal rotary blades are located on both sides of the continuous bread tube 302. The rotary blades rotate about an axis perpendicular to the horizontal plane of the bread tube. In one embodiment, two bread tubes 302 are placed on either side of the horizontal rotary blade to simultaneously split more than one bread tube 302 at a time. When rotary blades are used, they are optionally assisted by ultrasonic or other suitable technology to prevent residue from building up on the blades. In one embodiment, the splitter 300 is located towards the end of the vacuum conveyors 308, 312 where the bread tube 302 exits the splitter 300. In the embodiments where rotary blades are used, the leading end of the bread tubes 302 (i.e., the bread end formed at the very beginning of the continuous process) are trimmed to allow the bread tubes 302 to open up into two halves 304, 306.

In another embodiment shown in FIG. 3B, the splitting mechanism 310 is a scallop-edged band saw. The band saw is located at the exit end of the vacuum conveyors 308, 312, and splits the bread tube 302 into top half 304 and bottom half 306. The splitting mechanism 310 cuts along the vertical center, and splits the bread tube 302 into top half 304 and bottom half 306. In some embodiments, the band saw is assisted by suitable knife technology to prevent residue build-up. In other embodiments, the splitting mechanism 310 is any suitable mechanism to continuously split 210 the continuous bread tube 302. One advantage of some embodiments of the disclosed process is that the continuous bread tubes 302 produced have less wrinkled surface, which results in further reduction of product wastage during the optional splitting step.

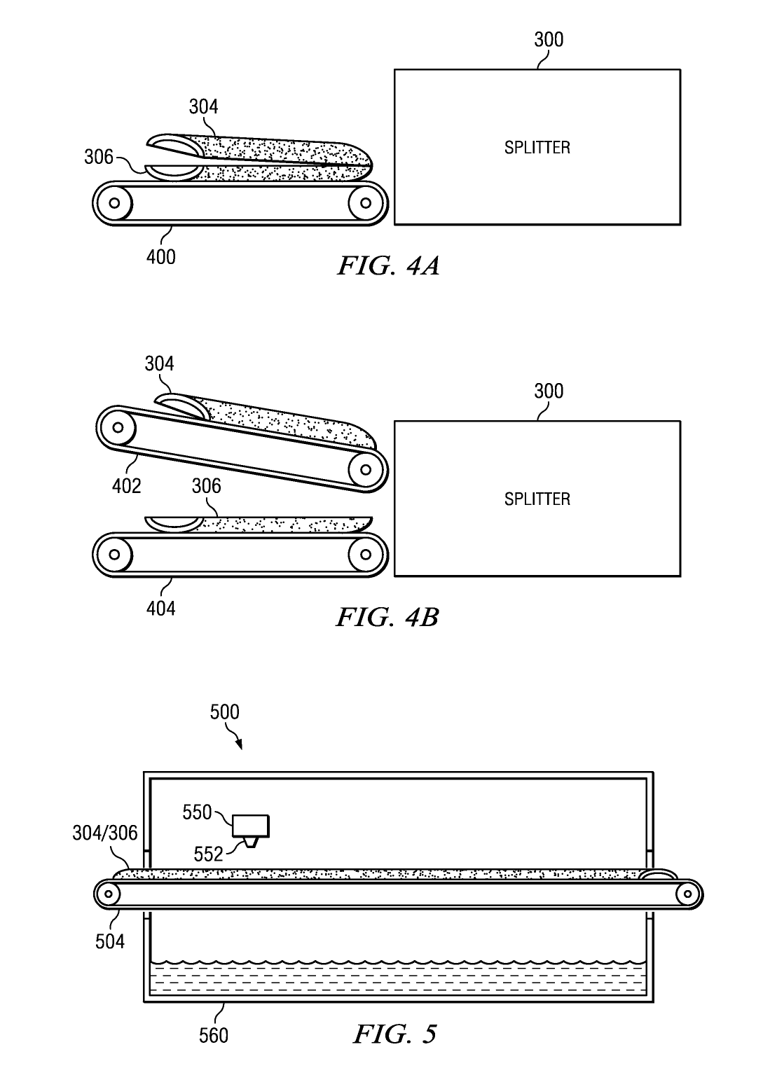

Once the pita bread tube 302 is split into two halves 304, 306 in the splitting step 210, they are transferred to the subsequent steps in at least two different ways. In one embodiment, as illustrated in FIG. 4A, the top half 304 is released from the top vacuum conveyor 308, thereby allowing the top half 304 to fall on to the bottom half 306, with both halves 304, 306 thereafter resting on single-tiered takeaway conveyor 400. The two halves 304, 306 are then carried away together. In another embodiment, as illustrated in FIGS. 3C and 4B, the two halves 304, 306 are transported using a two-tiered takeaway conveyor 402, 404. The two-tiered takeaway conveyor has a top takeaway conveyor 402 and a bottom takeaway conveyor 404. The top half 304 and bottom half 306 of the bread tube are kept separate and transported by top takeaway conveyor 402 and bottom takeaway conveyor 404, respectively. The single-tiered 400 or two-tiered 402, 404 takeaway conveyors are belt conveyors, vacuum conveyors, or a combination of the two in various embodiments.

One of the advantages of splitting 210 the bread tubes 302 is that it exposes the inner or crumb side to make it look like a manually split, artisan pita loaf. Crumb exposure adds to the consumer's eating experience by providing the unique pita crumb texture. Thus, one of the benefits of using a two-tiered takeaway conveyor 402, 404 is that it helps to maintain the crumb-side texture by transporting the top half 304 and bottom half 306 of the bread tube separately.

In some embodiments, the split tubes 304, 306 are optionally sprayed on the crumb sides with anti-adhesive liquid that inhibit re-adhesion. In at least one embodiment, the anti-adhesive liquid is also a flavor-enhancing agent, such as oil. The split tubes 304, 306 maintain the crumb texture and do not re-adhere to one another even when they are transported using a single-tiered takeaway conveyor 400.

2. Unsplit-Tubes

In some embodiment, Applicants' process 200 bypasses the splitting step 210 and transports the unsplit bread tubes 302 to subsequent steps. One of the advantages of bypassing the splitting step is obviating the need to use vacuum conveyors 308, 312, 314, vacuum rollers 316, 318, or two-tiered takeaway conveyor 402, 404, thereby lowering operational costs.

Another advantage of unsplit tube 302 is the ability to make two-ply pita bread or chips with the look and feel of traditional, hand-made pita loaves. In one embodiment, the unsplit tubes 302 are optionally subjected to a pressing step using a knock-down roll press, nub roll press, or other device that presses the top and bottom layers together at specific points. The pressing step occurs either before or after the curing step 214 shown in FIG. 2.

In some embodiments, unsplit tubes 302 are optionally sprayed on the crumb side or the outer layer with anti-adhesive liquids. Furthermore, crumb exposure in unsplit tubes 302 is achieved by trimming 216 techniques (described below).

### D. Optional Filling Step

Consumers often dip pita chips in hummus or other dips. The filling flavors are chosen to imitate such experience in some embodiments. Alternatively, fruit- or vegetable-based fillings are chosen in other embodiments to enhance the nutritional value and attract health-conscious consumers. The fillings may be both of sweet or savory type. The choice of filling is determined by various factors, including flavor, mouthfeel, nutritional value, and water activity of the filling material.

One advantage of splitting 210 the bread tubes 302 is that it is capable of being filled easily (at the filling step 212) with various fillings between the top half 304 and bottom half 306 of the bread tubes. In such embodiments, once the filling material is placed between the top half 304 and bottom half 306 of the bread tubes, they are optionally pressed using a knock-down roll press, nub roll press, or other device that presses the top and bottom layers. The pressing step helps to ensure adhesion between the bread and the filling layers.

### E. Curing Step

The sequence of the optional splitting step 210, optional filling step 212, and the accelerated curing step 214—as well as the optional steps of pressing and spraying anti-adhesive liquid—are largely interchangeable. For example, in one embodiment, the bread tubes 302 proceed to the curing step 214 after the optional splitting step 210 and the optional filling step 212. In an alternative embodiment, the optional splitting step 210 and the optional filling step 212 occur after the curing step 214. Yet in another embodiment, the optional splitting step 210 occurs before the curing step 214, and the optional filling step 212 occurs after the curing step 214.

As used herein, curing 214 means a process by which the moisture content is equilibrated throughout the bread. The curing process also facilitates starch retrogradation. In one embodiment, the desired uniform moisture level after curing ranges from about 20 to about 36%, and preferably about 28%. In some embodiments, if the unsplit pita tubes 302 or split tubes 304, 306 do not have a tackiness or re-adhesion issues, the curing step can optionally be bypassed.

In one embodiment, the curing step 214 occurs in a dryer or oven uses electromagnetic frequency in the range of about 10 megahertz (MHz) to about 3 gigahertz (GHz). In the to 100 MHz range, the apparatus is generally referred to as a radio frequency (RF) dryer. The so-called “inside out drying” process imparted by an RF dryer equilibrates the moisture level. In one embodiment, the continuous pita tubes 302 (or split tubes 304, 306) pass between electrodes having an alternating electric field which reverses its polarity at a rate of about 40 megahertz. When passing through an alternating electric field, polar molecules constantly realign themselves to face the opposite pole. At a frequency of 40 megahertz, this rapid movement causes the polar molecules of water to quickly heat, wherever moisture is present, throughout the entire thickness of the product. Nonpolar materials such as fat, oil, and dry ingredients do not react and, therefore, are not directly heated by RF energy. Thus, anti-adhesive liquids can optionally be applied before the curing step 214. In the case of unsplit pita bread tubes 302, the wettest area of the bread (i.e., inside the tube) will absorb more of the RF energy and will preferentially dry the inside. Further curing the bread tubes 302 after this equilibration process also brings down the total moisture of the bread tubes 302.

By using an RF dryer in one embodiment, the bread tubes 302 are uniformly and quickly cured 214. Curing in ambient conditions can last anywhere from 8 to 24 hours, depending on temperature and humidity. Applicants' accelerated RF curing 214 process reduces the curing dwell time significantly. In one embodiment, the temperature inside the RF dryer ranges from about 35° C. to about 150° C., and the dwell time ranges from about 15 to about 60 seconds and preferably between about 20 to about 30 seconds.

If both bread tube halves 304, 306 are transported using the single-tiered conveyor 400, as illustrated in FIG. 4A, then they enter a single-tiered RF dryer. If the halves 304, 306 are transported using the two-tiered takeaway conveyors 402, 404, as illustrated in FIG. 4B, they enter a two-tiered RF dryer.

In an alternative embodiment, the curing step 214 occurs in a two-tiered, high air-convection oven. As used herein high air-convection oven means a heating apparatus that has high heat transfer coefficient (e.g., from about 30 to about 1000 watts per square meter per degree Celsius). A further alternative embodiment uses an infrared heat source at the curing step 214. In one embodiment, a two-tiered, double impingement oven is used. Because impingement is mostly a surface phenomenon, this embodiment of curing process work better with split tubes 304, 306. In such embodiments, the internal air temperature of the oven is in the range of about 60° C. to 400° C. An advantage of using a convection oven is the ability to enhance the flavor and coloring of the bread through, for example, browning.

### F. Trimming Step

As the split halves 304, 306 (or unsplit tube 302) exits the curing step 214, they proceed to the trimming step 216 where they are cut into chip-sized pieces using a trimmer. As used herein, trimmer means any mechanical means operable to continuously cut the bread tubes 302 or split tubes 304, 306 longitudinally and laterally. As used herein, lateral or laterally means in the general direction perpendicular to the longitudinal direction of the bread tube 302 or split tubes 304, 306. In various embodiments, he chip-sized pieces are cut to different final shape, such as square, rectangle, parallelogram, triangle, or other polygons.

There are various methods for continuously trimming 216 chip-sized pieces. For example, a cutting roller, a mechanical crushing, ultrasonic cutting, or shearing methods can be used. But these methods may pose problems in unsplit tubes 302. Cutting rollers or mechanical shears push the top layer 304 down onto the bottom layer 306 of the pita bread tube 302, thereby crimping the edges and welding the two layers together. This will seal off the crumb side (i.e., inner surface of the tube). As a result, the pita chips will pillow again once it enters the finish cooking stage, thereby causing increased breakage and differences to finished chip texture. Crumb exposure ensures that the pita chips do not puff up again in the finish cooking device. Therefore, maintaining the crumb exposure during the trimming 216 step may be beneficial. Further, if conventional cutting methods are used, the bread tubes 302 undergo extensive cooling to avoid cut edges from crimping. Cooling is a highly energy- and space-inefficient. Moreover, transporting the bread tubes 302 to and from a cooler, requires cutting the bread tubes 302 at a certain length, which is undesirable for a continuous process.

In one embodiment, the trimmer is a continuous water jet cutting system 500 (see FIG. 5) that is capable of trimming 216 the bread tube 302 or halves 304, 306 without crimping the edges and ensuring excellent crumb exposure at about 93° C., i.e., without cooling. The water jet cutting system 500 comprises a pressure system that delivers water under pressure, a water collection system, and a motion system. The water jet cutting system 500 is capable of operating while in communication with a continuous conveyor on which the bread tubes are transported.

Referring to FIG. 5, the basic elements of the water jet cutting system 500 are seen. The motion system comprises a cutting head 550 and a permeable conveyor system 504 that is transporting the continuous halves 304, 306 (as depicted) or a continuous loaf 302 through the trimming step 216. As used herein, the cutting head 550 comprises one or more movable water jet nozzles 552, optionally in an array, and the accompanying equipment that controls the movement of the cutting head 550. The water jet nozzles 552 are in communication with the pressure system by way of a high-pressure water line (not shown). The conveyor 504 is perforated or otherwise permeable to allow the water from the jet to drip to a catcher tank 560 below.

Continuous water jet cutting systems often utilize a jet nozzle that travels along a single linear, angled path across a product bed (e.g., the width of an array of bread tube 302 or halves 304, 306 on the permeable conveyor system 504) at a precise speed resulting in a straight line cut across the continuous product strips transported on a conveyor. The jet nozzle starts at the leading edge of the product bed and reaches the lagging edge, and the jet nozzle must return to its starting position for the next cutting phase. During the return phase, the water flow must be stopped to prevent the continuous product strips from being cut at an angle to form irregularly shaped pieces. Conventional water jet systems use diverter or shut-off valves to stop the water flow through the jet nozzle. A diverter or shut-off valves must withstand enormous pressure, thus naturally are high-wear parts requiring frequent replacements.

In one embodiment, Applicants employ a water pressure of 13,000 psi (914 kilograms per square centimeter) in their pressure system. Conventional water jet cutting operation, on the other hand, utilizes water pressures from 30,000 psi to 60,000 psi. As used herein, low-pressure water jet cutting system means a water jet cutting system utilizing water pressures below that of a conventional water jet system, or below 30,000 psi. In one embodiment, the low-pressure water jet cutting system 500 utilizes pressures below 30,000 psi and preferably about 10,000 to about 25,000 psi. At the lower pressure, Applicants dramatically reduce the flow rate and the power requirements, rendering this technology more practical. The amount of wear on pressure components are also reduced with the use of lower operating pressures. Because the Applicants' process is continuous and therefore does not go through start-stop cycles, it reduces wear on the parts.

The processing speeds of Applicant's water jet cutting system 500 are very high compared to conventional water jet cutting systems. In one embodiment, the continuous pita strips pass through the water jet cutting system 500 at speeds of about 30 meters per minute with chip piece length of about 5 centimeters across a product bed of about 125 centimeters. Increased speeds allow for higher throughputs, thereby increasing productivity of the process as a whole.

When the cutting head 550 is on a path outside the conveyor width, the water stream travels directly to a catcher tank 560 below, shown in FIG. 5. The water collection system comprises the catcher tank 560 and a mist control system. The catcher tank 560 is large enough to cover the entire path of the cutting head 550. The impact of the water jet on the catcher tank 560 below the conveyor 504 causes a high amount of mist formation in the cutting chamber. The mist has a potential to settle back on the pita strips, thereby increasing its moisture content and decreasing the efficiency of the process (as the moisture will need to be removed again). As used herein, mist control system is a system that decreases or inhibits the mist formed by water jets from settling on the pita product during the trimming step 216. In one embodiment, Applicants use a combination of jet dissipaters, such as stainless steel mesh vanes, as a part of the mist control system. In another embodiment, Applicants force increased air flow (with a vacuum pump or blower) to significantly reduce mist formation.

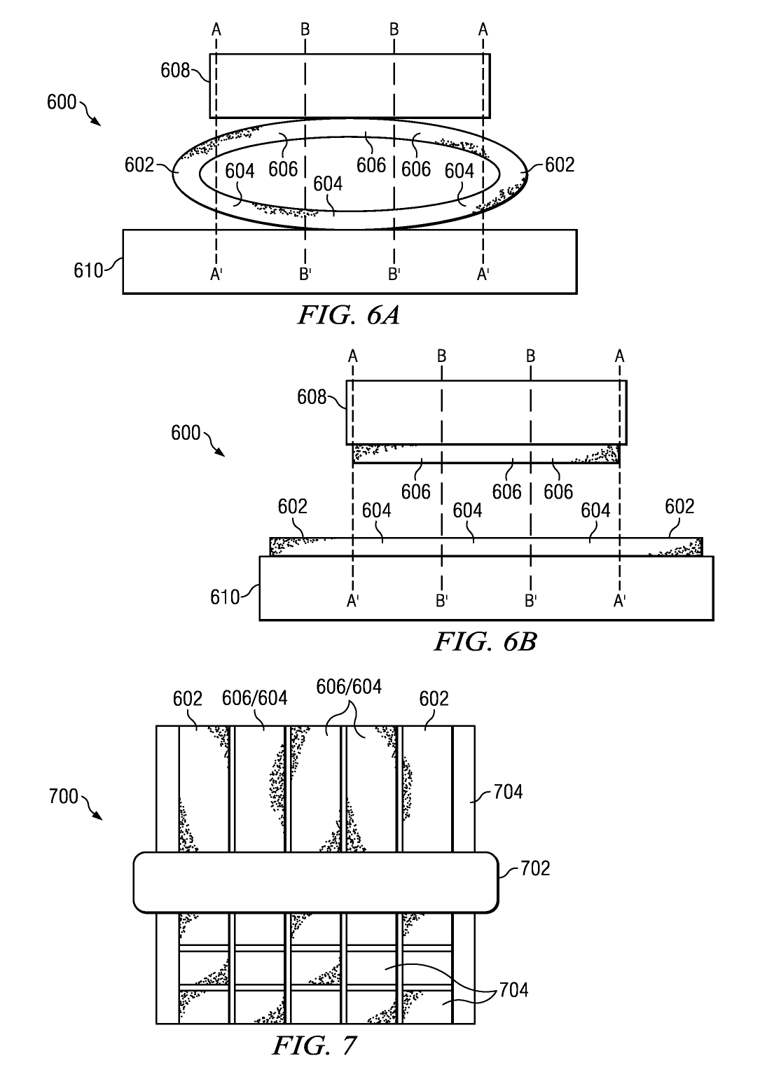

In some embodiments, the unsplit tube 302 is trimmed 216 to expose the crumb side, as shown in FIGS. 6A and 6B. The trimmer 600 has two or more cutting paths: A-A′ and B-B′. The A-A′ path cuts the bread tube 302 along the edges so that the edge piece 602, which is folded to about half the width (when viewed from the top) of the middle piece 604, 606. In other words, the distance between A and B is about double that of the distance between A and the edge of the bread 302. Depending on the width of the bread 302 and the desired size of the resultant chips, the distance between A and B and the number B-B′ lines is adjusted accordingly. After it is trimmed 216, the edge pieces 602 become unfolded, and falls flat on the conveyor 610 (FIG. 6B). Thus, after trimming 216 the width of the edge pieces 602 and the middle pieces 604, 606 are substantially the same. The middle pieces 604 of the bottom layer are transported on the conveyor 610. The middle pieces 606 are transported using a vacuum conveyor 608.

In one embodiment, the trimmer 600 trims both longitudinally and laterally across the product bed. In an alternative embodiment, the trimmer 600 trims only longitudinally, and a separate lateral trimmer 702 cuts across the product bed 704 to make chip-sized pieces (FIG. 7). Both the trimmer 600 or the lateral trimmer 702 can be a water-jet cutting system 500 or any other suitable cutting mechanism. The middle pieces 606 of the top layer are trimmed with the middle pieces 604 of the bottom layer in some embodiments; in other embodiments, they are transported to a separate trimmer.

### G. Optional Finish Steps

In one embodiment, when the unsplit tubes 302 are trimmed 216, the resultant chip-sized pieces mimic traditional pita bread with crumb side in the center. These “two-layered” pita chips can have higher moisture content inside the pocket than at the surface, so these chips are optionally subjected to a moisture level equilibration or drying 218 step in another RF dryer. The drying step also ensures that any mists trapped inside the pocket during the water jet trimming step 216 is removed. This step also reduces the dwell time of the chip-sized pieces in the final finish cooking stage 222 to the extent that the extra moisture is removed in the drying step 218. The moisture level after the drying step 218 in one embodiment is between about 5 to about 30% water by weight.

After either the trimming step 216 or the optional drying step 218, the resultant product is subjected to an optional cooling step 220. The cooling step 220 occur in an ambient environment or a spiral cooler in various embodiments. In some embodiments, the cooling takes about 10 minutes in ambient condition.

The individual chip-sized pieces (whether made from split halves 102, 104 or the unsplit tubes 302) are finish cooked 222 to the final moisture content of about 1 to about 2.5% water by weight. The finish cooking step 222 occurs in any cooking device that capable of removing moisture from the chip-sized pieces. In some embodiments, the finish cooking device is a type of oven, such as a convection oven. Following this step 222, the pita chip products are packaged and shipped. The low moisture content of the final product, typically between about 1 and about 2.5%, allows for longer shelf-life.

There are numerous advantages of Applicants' method 200 all being carried out in an automated, continuous process. Eliminating manual handling decreases labor cost as well as product breakage and the resultant loss. Also, because the bread tubes 302 are not subjected to the variations in conditions during conventional curing, product uniformity is increased. Use of vacuum conveyors 308, 312 along with a splitting mechanism 310 (whether rotary blades, band saw, or similar devices) also increases product uniformity compared to manually splitting the bread loaves or other mechanical processes. Also, the elimination of lengthy ambient curing and cooling steps obviates the need for separate storage space for the loaves. The flexibility of the Applicants' method 200—i.e., the ability to order several steps interchangeably—adds new dimensions to the pita chip production process. For example, the bread tube 302 can be treated with anti-adhesion liquid, sandwiched favor with flavored fillings, pressed together, or par-baked in an impingement oven.

The Applicants' new method 200 is made possible by a combination of the various components described herein, including: splitter 300 coupled to vacuum rollers 316, 318, or vacuum conveyors 308, 312, 314, the single-tired RF dryer, the two-tiered RF dryer, the two-tiered impingement oven, the water-jet cutting system 500, and the trimmers 600, 700.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the spirit and scope of the appended claims. Alternative embodiments that result from combining, integrating, or omitting features of the embodiments are also within the scope of the disclosure.

In order to assist the United States Patent and Trademark Office (USPTO) and any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this invention in any way that is not otherwise reflected in the appended claims.

1. A continuous method of making chips, the method comprising the following steps:
a) sheeting bread dough into a continuous dough sheet;
b) cutting the continuous dough sheet longitudinally into continuous dough strips;
c) cooking a continuous dough strip in a continuous oven, thereby producing a continuous bread tube, wherein the continuous bread tube comprises a cavity, a top surface, and a bottom surface;
d) curing the continuous bread tubes in less than about 60 seconds; and
e) trimming the continuous bread tubes into chip-sized pieces using a trimmer.

2. The method of claim 1, further comprising proofing the continuous dough sheet after sheeting of step a).

3. The method of claim 1, wherein curing of step d) occurs in a radio frequency oven.

4. The method of claim 1, wherein curing of step d) occurs in a convection oven.

5. The method of claim 1, wherein the continuous bread tube has a cavity moisture level of about 32% by weight after the cooking of step c).

6. The method of claim 1, wherein the continuous bread tube after the curing step d) has a moisture level ranging from about 20 to about 34% by weight.

7. The method of claim 1, further comprising splitting the continuous bread tube longitudinally into a top half and a bottom half using a splitting mechanism prior to the trimming of step e).

8. The method of claim 7, further comprising a spraying step wherein the spraying step comprises spraying the continuous bread tube of step c) with an anti-adhesive liquid to remove tackiness of the top half and the bottom half.

9. The method of claim 1, further comprising spraying the continuous bread tube of step c) with an anti-adhesive liquid to remove tackiness of the top surface and the bottom surface.

10. The method of claim 1, further comprising flattening the continuous bread tube without re-adhering of the top surface and the bottom surface before the trimming step e).

11. The method of claim 1, wherein the trimmer of step e) is a continuous low-pressure water jet cutting system.

12. The method of claim 1, wherein trimming of step e) exposes the cavity.

13. The method of claim 1, further comprising drying the chip-sized pieces after the trimming of step e).

14. The method of claim 1, further comprising cooling the chip-sized pieces after the trimming of step e).

15. A chip produced by the method of claim 1.

16. A continuous method of making chips, the method comprising the following steps:
a) sheeting bread dough into a continuous dough sheet;
b) cutting the continuous dough sheet longitudinally into continuous dough strips;
c) cooking a continuous dough strip in a continuous oven, thereby producing a continuous bread tube, wherein the continuous bread tube comprises a cavity, a top surface, and a bottom surface;
d) splitting the continuous bread tube longitudinally into a top half and a bottom half using a splitting mechanism assisted by a vacuum apparatus;
e) curing the continuous bread tube in less than about 60 seconds; and
f) trimming the continuous bread tubes into chip-sized pieces using a trimmer.

17. The method of claim 16, further comprising proofing the continuous dough sheet after sheeting of step b).

18. The method of claim 16, wherein the vacuum apparatus of step d) comprises a top vacuum conveyor, wherein the top vacuum conveyor is coupled to the top surface of the continuous bread tube.

19. The method of claim 18, wherein the vacuum apparatus of step d) comprises a bottom vacuum conveyor registered with the top vacuum conveyor, wherein the bottom vacuum conveyor is coupled to the bottom surface of the continuous bread tube.

20. The method of claim 16, wherein the splitting mechanism of step d) is coupled to vacuum rollers.

21. The method of claim 16, wherein the splitting mechanism of step d) comprises a plurality of horizontal rotary blades.

22. The method of claim 16, wherein the splitting mechanism of step d) comprises a scallop-edged band saw.

23. The method of claim 16, further comprising applying a filling between the top half and the bottom half of the continuous bread tube after step c).

24. The method of claim 16, wherein the top and the bottom halves of the continuous bread tube formed by step d) are transported together using a single-tier takeaway conveyor.

25. The method of claim 16, wherein the top and bottom halves of the continuous bread tube formed by step d) are transported separately using a top takeaway conveyor and a bottom takeaway conveyor, respectively.

26. The method of claim 16, wherein curing of step e) occurs in a continuous two-tiered radio frequency dryer comprising a top tier and a bottom tier.

27. The chip produced by the method of claim 16.

28. A continuous chip production line comprising a series of unit operation each unit operation in communication with another continuous chip production line comprising:
a sheeter in communication with a cutter, the cutter in further communication with a cooking oven, the cooking oven in further communication with a first radio frequency dryer, the first radio frequency dryer in further communication with a trimmer.

29. The continuous chip production line of claim 28, further comprising a proofer located between and in communication with the sheeter and the cutter.

30. The continuous chip production line of claim 28, further comprising a splitter located between and in communication with the cooking oven and the first radio frequency dryer.

31. The continuous chip production line of claim 30, wherein the conveyor between the cooking oven and the splitter further comprises a top vacuum conveyor coupled to a top surface of a bread product being transported thereon.

32. The continuous chip production line of claim 31, wherein the conveyor further comprises a bottom vacuum conveyor registered with a top vacuum conveyor, wherein further the bottom vacuum conveyor is coupled to a bottom surface of the bread product transported thereon.

33. The continuous chip production line of claim 30, wherein the splitter comprises a plurality of horizontal rotary blades.

34. The continuous chip production line of claim 30, wherein the splitter comprises scallop-edged band saw.

35. The continuous chip production line of claim 30, wherein the first radio frequency dryer comprises a two-tiered radio frequency dryer comprising a top tier and a bottom tier.

36. The continuous chip production line of claim 30, wherein the conveyor located between the splitter and the first radio frequency dryer comprises a single-tier takeaway conveyor.

37. The continuous chip production line of claim 30, wherein the conveyor located between the splitter and the first radio frequency dryer comprises a top takeaway conveyor and a bottom takeaway conveyor.

38. The continuous chip production line of claim 28, wherein the trimmer comprises a continuous low-pressure water jet cutting system further comprising:
a pressure system;
a water collection system;
a motion system comprising a cutting head and a permeable conveyor system; wherein the pressure system delivers water under pressure to the cutting head, and wherein further the permeable conveyor system is located between and is in communication with the first radio frequency oven.

39. The continuous chip production line of claim 28, further comprising a second radio frequency dryer adjacent to and in communication with the trimmer.

40. The continuous chip production line of claim 39, further comprising a cooling system adjacent to and in communication with the second radio frequency dryer.
